(19) United States
(12) Patent Application Publication
(10) Pub. No.: US 2022/0134329 A1
(43) Pub. Date: May 5, 2022

(54) INTERNAL POSITIVE CONTROL FOR DIAGNOSTIC ASSAYS

(71) Applicant: Analog Devices, Inc., Wilmington, MA (US)

(72) Inventors: Joyce WU, Somerville, MA (US); Edward Joseph DANYLIW, San Francisco, CA (US); David BOLOGNIA, Charlestown, MA (US); Jiawen BAI, Brighton, MA (US)

(73) Assignee: Analog Devices, Inc., Wilmington, MA (US)

(21) Appl. No.: 17/516,909

(22) Filed: Nov. 2, 2021

Related U.S. Application Data
(60) Provisional application No. 63/110,221, filed on Nov. 5, 2020.

(51) Int. Cl. B01L 3/00

(52) U.S. Cl. CPC B01L 3/5029; B01L 2200/0689; B01L 2200/10; B01L 2200/16; B01L 2300/042; B01L 2300/0832; B01L 2300/044; B01L 2300/047; B01L 2300/0663; B01L 2300/0672; B01L 2300/043

(57) ABSTRACT

A method of verifying proper functionalization of a sensor and a negative test result obtained by exposing a sensing element functionalized to detect a target analyte to a test sample is described. The method may include, subsequent to or simultaneously with the exposing the sensing element to the test sample, exposing the sensing element to a test confirmation sample, the test confirmation sample comprising at least one of the target analyte in an amount greater than a detection limit of the sensing element and a recombinant protein of the target analyte in an amount greater than a detection limit of the sensing element and performing a measurement using the sensing element to obtain a subsequent test result.

### RELATED APPLICATIONS

This application claims priority to U.S. Provisional Patent Application No. 63/110,221 filed Nov. 5, 2020, entitled “INTERNAL POSITIVE CONTROL FOR DIAGNOSTIC ASSAYS” the disclosure of which is hereby incorporated by reference in its entirety.

### FIELD OF THE DISCLOSURE

This disclosure relates in general to the field of diagnostic assays, and more particularly, though not exclusively, to a system and method for internal positive controls for such diagnostic assays.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1A is a schematic perspective view of a sample testing device according to an embodiment.

FIG. 1B is a schematic bottom plan view of the sample testing device illustrated in FIG. 1A.

FIG. 2A is a schematic cross-sectional side view of the sample testing device of FIG. 1A in a first state (a closed or locked state).

FIG. 2B is a schematic cross-sectional side view of the sample testing device of FIG. 1A in a second state (an opened or unlocked state).

FIG. 3 is a schematic perspective view of the sample testing device of FIG. 1A near a sensor assembly of the sample testing device showing an air vent flow.

FIG. 4A is a schematic cross-sectional side view of the sensor assembly of the sample testing device of FIG. 1.

FIG. 4B is a schematic perspective view of the sensor assembly as seen from a sensing side.

FIG. 4C is a schematic perspective view of the sensor assembly as seen from a buffer side.

FIG. 5 is a schematic perspective view of the sensor assembly.

FIG. 6A is a side view of the mechanical locking structure having an unplugged physical status and an open circuit status.

FIG. 6B is a side view of the mechanical locking structure having a plugged physical status.

FIG. 6C is a side view of the mechanical locking structure having a turned physical status.

FIG. 7A is a schematic cross-sectional side view of a sample testing device in a step in a sample testing process.

FIG. 7B is a schematic cross-sectional side view of a sample testing device in another step in the process.

FIG. 7C is a schematic cross-sectional side view of a sample testing device in another step in the process.

FIG. 7D is a schematic cross-sectional side view of a sample testing device in another step in the process.

FIG. 7E is a schematic cross-sectional side view of a sample testing device in another step in the process.

FIG. 7F is a schematic cross-sectional side view of a sample testing device in another step in the process.

FIG. 8A is a schematic exploded view of a sensor assembly having a substrate, a sensing element, and an adhesion layer, according to another embodiment.

FIG. 8B is a schematic perspective top view of the sensor assembly of FIG. 8A without the sensing element and the adhesion layer.

FIG. 8C is a schematic perspective bottom view of the sensor assembly of FIG. 8A without the sensing element and the adhesion layer.

FIG. 8D is a schematic cross-sectional side view of a portion of the sensor assembly of FIG. 8A.

FIG. 8E is a schematic perspective view of a plurality of electrodes of the sensor assembly of FIG. 8A.

FIGS. 9A and 9B illustrate an internal control mechanism for a sample testing device according to one embodiment.

FIGS. 10A and 10B illustrate an internal positive control mechanism for a sample testing device according to another embodiment.

FIGS. 11A-11F illustrate an internal positive control mechanism for a sample testing device according to yet another embodiment.

### DETAILED DESCRIPTION

In diagnostics, tests are often assays that may include internal positive and/or negative controls to determine whether the test has run properly and/or to confirm that the test result is valid. Assays may be nucleic acid-based tests, or immunoassays, protein-based tests such as enzyme-linked immunosorbent assays (ELISAs), or lateral flow assays.

As previously noted, assays may include internal positive controls, which are performed to ensure that the test was run properly and to reduce the risk of false negative results, and/or negative controls, which help rule out false positive results or non-specific binding. For example, lateral flow immunoassays, such as pregnancy tests, use one or more control lines for positive controls. In particular, an anti-species antibody at the control line will bind to nanoparticles from the conjugate pad to demonstrate that the test has run. However, this only confirms that the sample has passed through the test line (which typically precedes the control line) and does not verify the accuracy of the biochemistry of the test line. ELISA tests use separate wells for controls, so the capture antibody of the target analyte in the well with the sample is not specifically verified for efficacy/accuracy. Nearby wells are used for controls, with the assumption being that the capture antibody is operable for all of the wells. In nucleic acid-based test, the internal control may be a non-target nucleic acid sequence that is co-extracted and co-amplified with the target nucleic acid.

A sample testing device can include a sensing device for sensing properties of a chemical, e.g., a fluid substance such as a biological fluid. In some embodiments, the sample testing device can be used for detecting a biomolecule in a fluid substance, by sensing a bacteria or a virus, for example, influenza, SARS-CoV-2 (the virus which causes COVID-19), or any other suitable micro-organism. The testing device can be used to detect any suitable type of biological substance or micro-organism. Various embodiments disclosed herein relate to a sample testing device. In some embodiments, the sample testing device can comprise a sensing device. In some embodiments, the sample testing device can comprise a testing tube that receives a biological fluid substance for testing.

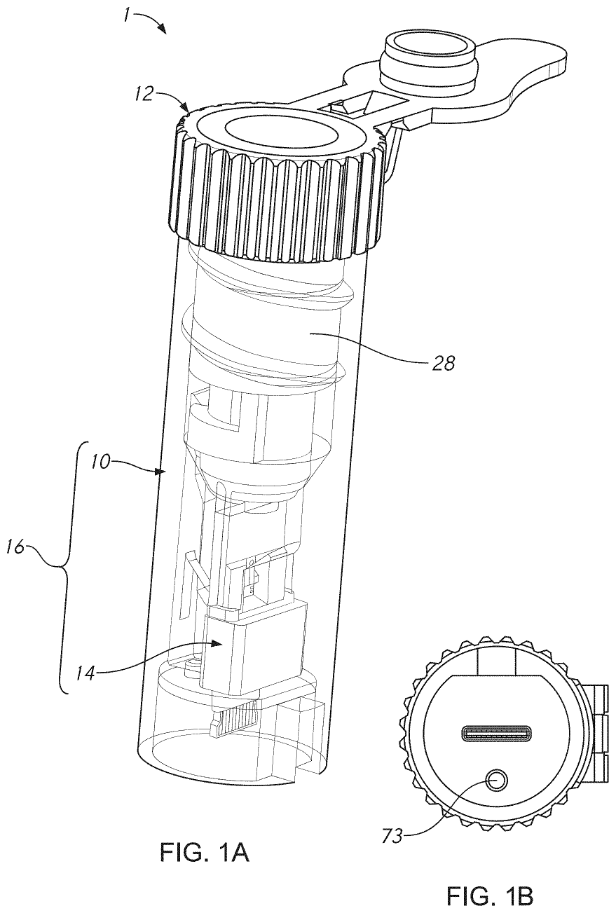

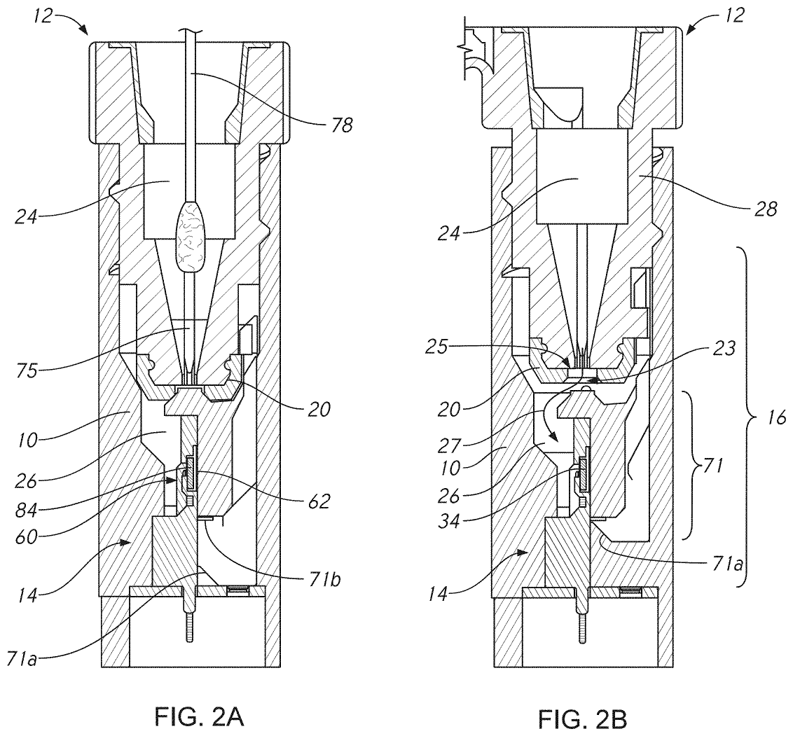

FIG. 1A is a schematic perspective view of a sample testing device 1 according to an embodiment. FIG. 1B is a schematic bottom plan view of the sample testing device 1 illustrated in FIG. 1A. FIG. 2A is a schematic cross-sectional side view of the sample testing device 1 in a first state (a closed or locked state). FIG. 2B is a schematic cross-sectional side view of the sample testing device 1 in a second state (an opened or unlocked state). In some embodiments, the sample testing device 1 can comprise a testing tube. The testing tube can include a cartridge housing 10, a cap 12, a sensor assembly 14 having a sensing element 34, a mechanical locking structure 16, and an activation feature 71. In some embodiments, the activation feature 71 can comprise a lock clip 71a and a detect pin 71b. The sample testing device 1 can include an unlock button 73 that is disposed on a bottom side of the test sampling device 1. A separator 20 can separate the testing tube into a plurality of (e.g., two) compartments. In some embodiments, the separator 20 can comprise an internal sealing gasket (not illustrated). In some embodiments, one of the two compartments can comprise a first sample mixing compartment 24 and the other one of the two compartments can comprise a second sensing compartment 26. The sample mixing compartment 24 can be defined at least in part by a sample mixing compartment housing 28. The sensing compartment 26 can be defined at least in part by the cartridge housing 10. The sample mixing compartment housing 24 can be coupled to the cap 12. The sample mixing compartment 24 can include a solution 75 prior to providing a test sample into the sample mixing compartment. The test sample can be delivered to the sample mixing compartment 24 using, for example, a swab 78. In some embodiments, the test sample can be mixed with the solution 75. In some embodiments, the separator 20 can open to allow fluid communication between the sample mixing compartment 24 and the sensing compartment 26. Therefore, the separator 20 can have the closed state in which there is no fluid communication between the sample mixing compartment 24 and the sensing compartment 26, and the opened state in which there is fluid communication between the sample mixing compartment 24 and the sensing compartment 26. In some embodiments, the separator 20 can open in response to a force applied to the sample testing device 1. For example, the separator 20 can open when the sample mixing compartment housing 28 and/or the cap 12 is twisted relative to the sensing compartment 30. The test sample can be transferred from the sample mixing compartment 24 to the sensing compartment 26 through an aperture 25 when the separator 20 is in the opened state. When the separator 20 is raised above a flange 23 (a part of the cartridge housing 10 that closes the hole), the aperture 25 enables the liquid sample to flow from the sample mixing compartment 24 to the sensing compartment 26 as shown in FIG. 2B as a liquid flow 27.

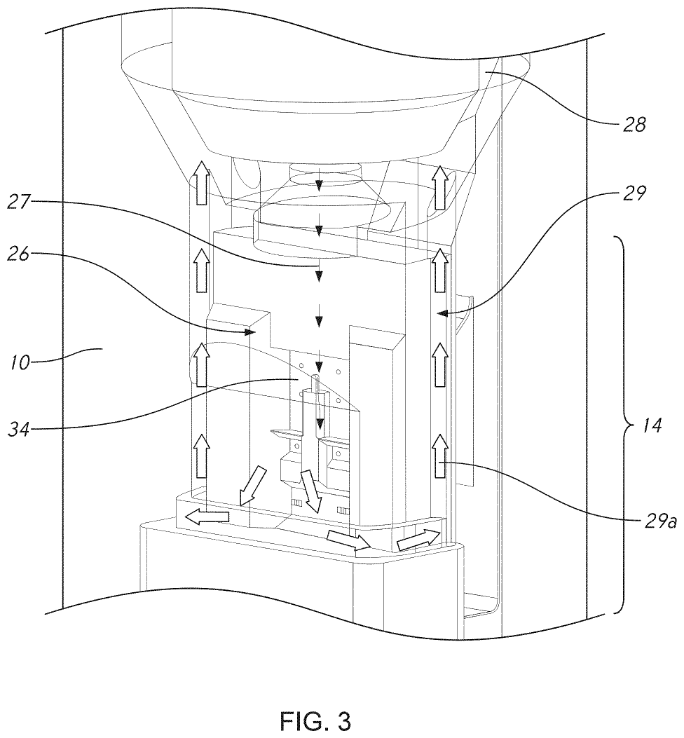

FIG. 3 is a schematic perspective view of the sample testing device 1 near the sensor assembly 14 showing an air vent flow 29a in a vent channel 29. When the separator 20 is in the opened state and fluid communication between the sample mixing compartment 24 and the sensing compartment 26 is made, the liquid sample can flow in the liquid flow 27 and the air in the sensing compartment 26 can vent out through the vent channel 29 as shown in FIG. 3. The vent channel 29 can facilitate and/or improve the liquid flow 27 in the sensing compartment 26.

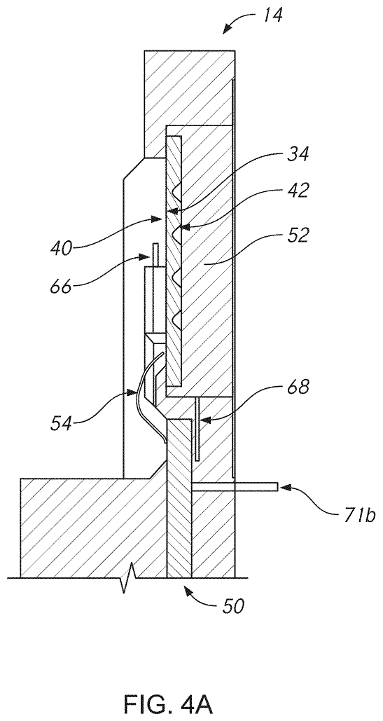

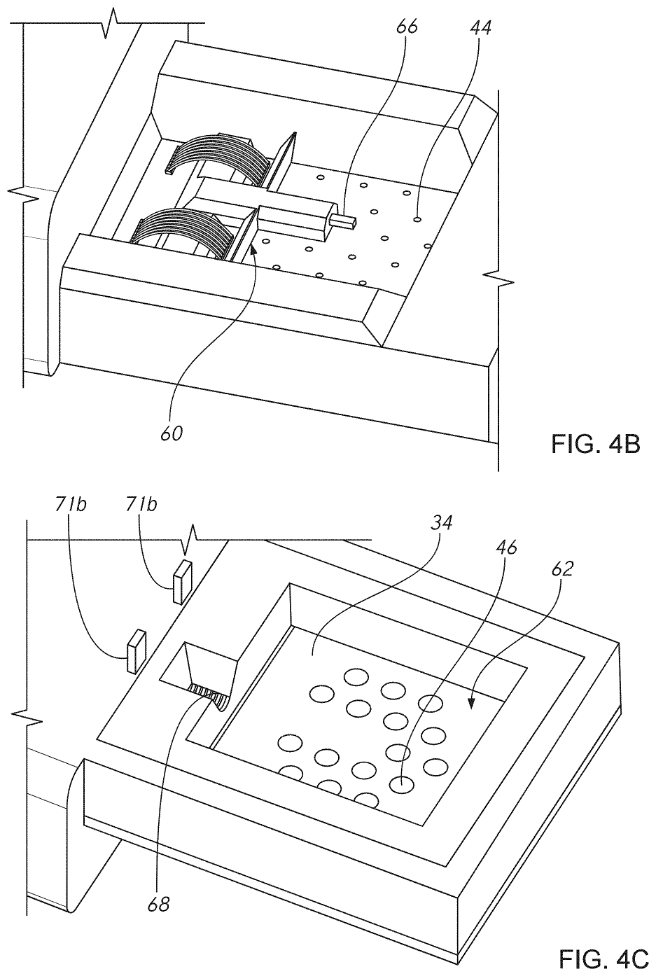

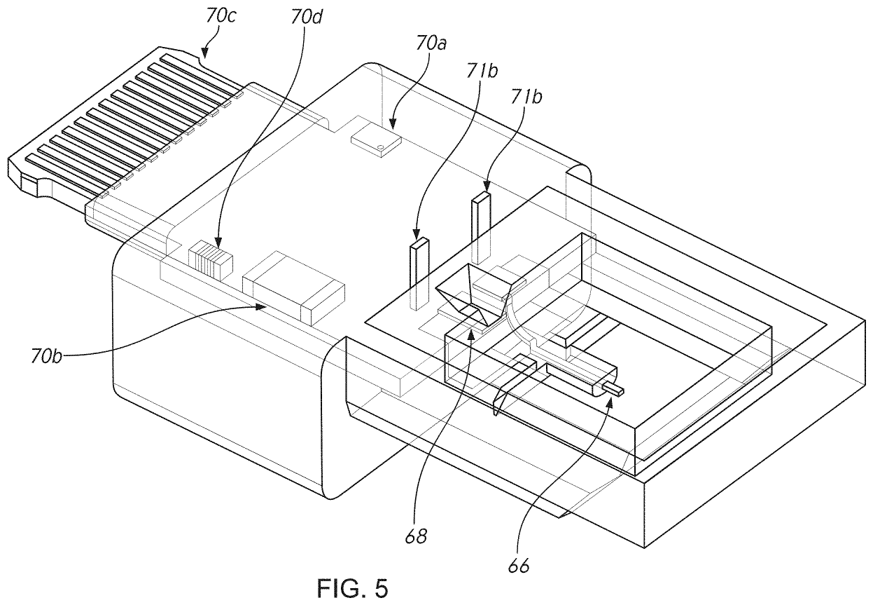

FIG. 4A is a schematic cross-sectional side view of the sensor assembly 14 of the sample testing device 1. FIG. 4B is a schematic perspective view of the sensor assembly 14 as seen from a sensing side 40. FIG. 4C is a schematic perspective view of the sensor assembly 14 as seen from a buffer side 42. FIG. 5 is a schematic perspective view of the sensor assembly 14. The sensor assembly 14 can comprise a sensing element 34. In some embodiments, the sensing element 34 can comprise a semiconductor (e.g., silicon) sensing element. The sensing element 34 can have the sensing side 40 or a sample side that makes contact with or is otherwise exposed to the test sample, and the buffer side 42 or a control side that is opposite the sensing side. The sensing element 34 can have a thickness of about 300 μm. For example, the thickness of the sensing element can be in a range of 150 μm to 450 μm, 250 μm to 450 μm, 150 μm to 350 μm, or 250 μm to 350 μm. In some embodiments, the sensing side 40 of the sensing element 34 can comprise a plurality of electrodes 44. In some embodiments, there can be sixteen electrodes on the sensing side 40 of the sensing element 34, but it should be appreciated that any suitable number of electrodes can be provided. The plurality of electrodes 44 can comprise any suitable material. For example, the plurality of electrodes 44 can comprise platinum (Pt). In some embodiments, the sensing element comprises a plurality of nanopores. The plurality of electrodes 44 can be disposed about the plurality of nanopores. For example, the electrode 44 can be disposed at least partially around the nanopore (e.g., disposed only about a portion of a perimeter of the nanopore, or completely around a nanopore. In some embodiments, each of the plurality of electrodes 44 can comprise two to several hundred nanopores. The plurality of nanopores can extend through a thickness of the sensing element 34. The buffer side 42 of the sensing element 34 can have cavities 46. The cavities 46 can be, for example, about 100 μm to 500 μm deep, or 200 μm to 400 μm deep. In some embodiments, the cavities 46 can comprise through holes that extend through an entire thickness of the sensing element 34. In some embodiments, the plurality of nanopores of the sensing element 34 can also comprise a functionalized layer, such as a biologic layer (e.g., including protein(s)), suitable for detecting a target chemical or biomolecule. In some embodiments, the protein layer can comprise a plurality of portions and each of the plurality of portions of the protein layer can be spotted in each nanopore of the plurality of nanopores. In some embodiments, each set of nanopores can have a different protein. For example, different protein can be used to detect different biological species, such as SARS-CoV-2 (the virus which causes COVID-19), rhinovirus, or any other suitable biological species.

The sensor assembly 14 can also include a package substrate 50 (e.g., a printed circuit board (PCB)), and a frame structure 52. In some embodiments, the package substrate 50 can be insert molded into the frame structure 52. In some embodiments, the frame structure 52 can comprise a medical grade acrylonitrile butadiene styrene (ABS) material. The sensing element 34 can be mounted to the frame structure 52 and electrically connected with the package substrate 50. For example, a portion of the sensing side 40 of the sensing element 34 can be bonded to the frame structure 52. In some embodiments, the sensing element 34 and the package substrate 50 can be electrically connected by way of bonding wires 54. In some other embodiments, the sensing element 34 can be electrically connected to the substrate 50 in another suitable manner. For example, the sensing element 34 can be flip-chip mounted to the substrate 50. For example, an anisotropic conductive paste (ACP) can be used to bond the sensing element 34 to the substrate 50. The package substrate 50 can be in electrical connection with the plurality of electrodes 44 on the sensing side 40 of the sensing element 34 by way of the bonding wires 54 and conductive lines or traces (not illustrated) formed on or in the sensing element 34.

The sensor assembly 14 can also comprise a sample reservoir 60 on the sensing side 40 of the sensing element 34 and a buffer reservoir 62 on the buffer side 42 of the sensing element 34. In some embodiments, the sensing compartment 26 can comprise and/or fluidly communicate with the sample reservoir 60. The sample reservoir 60 can receive the test sample from the mixing compartment 24 when the separator 20 is moved to the open position. The buffer reservoir 62 can hold a control material (e.g., a control liquid). In some embodiments, the control liquid can comprise a phosphate buffer saline (PBS). In some embodiments, the solution 75 that is mixed with the test sample and the control material can be the same. The sample reservoir 60 and the buffer reservoir 62 can be separated at least in part by the sensing element 34.

The sensing element 34 can measure a current through the plurality of nanopores. The current measured when the test sample is present in the sample reservoir 60 and the current measured when the test sample is not in the sample reservoir 60 can be compared to determine the presence of target molecules in the test sample. For example, voltage can be applied across the plurality of nanopores, and the changes in current measured through the plurality of nanopores can be analyzed to determine the presence of target molecules in the test sample. In some embodiments, the plurality of nanopores can comprise nanopores with different sizes, different shapes to enable testing of different probe molecules in one device. The current can be analyzed to monitor disturbance in the current, and determine a result of the testing. In some embodiments, a voltage source can generate a square-wave first at a voltage of −400 millivolts (mV), then at −200 mV, at 0 mV, and at +200 mV. Each specific pair of probe and target molecule can have a specific voltage at which they will bind. This changes the electrical characteristics of the nanopore opening, which alters the current, for example, at −200 mV. The change in the detected current can indicate that the target molecules are binding to the probe molecules in the presence of the −200 mV electric field, so the target molecules that bind to probe molecules at −200 mV are present in the sample. Two or more nanopores may test the same liquid sample or different liquid samples. The plurality of nanopores may be identical, or some or all of the plurality of set of nanopores may be different from each other. For example, the plurality of nanopores may have different sizes, different shapes, different numbers of nanopores, nanopores with different sizes or shapes, or nanopores with different probe molecules. Including different nanopores on a single sensing element 34 enables sensing element 34 to perform multiple different tests, e.g., to test for multiple different target molecules, to test with different sensitivities, or to include controls to verify the accuracy. For example, the testing results can include whether a person from whom the test sample is obtained is infected by a biological pathogen (e.g., a bacteria, virus, etc.) The sensor assembly 14 can test the test sample relatively quickly and accurately. Additional descriptions of a sensing element and sensing mechanism can be found in U.S. Patent Application Publication No. 2020/0326325, the entire disclosure of which is incorporated herein by reference for all purposes.

The sensor assembly 14 can also include a reference electrode 66 at least partially exposed to the sample reservoir 60, and a counter electrode 68 at least partially exposed to the buffer reservoir 62. The reference electrode 66 and the counter electrode 68 can comprise any suitable materials. In some embodiments, the reference electrode 66 can comprise silver (Ag), silver chloride (AgCl), or the like material. For example, the reference electrode 66 can comprise silver (Ag) and silver chloride (AgCl) as separate layers. In some embodiments, the counter electrode 68 can comprise platinum (Pt), silver (Ag), or Gold (Au). The reference electrode 66, the electrode on the sensing element 34 (e.g., a working electrode), and the counter electrode 68 can be used to monitor the disturbance in the current measured through the working electrode 44. For example, the reference electrode 66 and the counter electrode 68 can monitor voltage to maintain the voltage applied across the nanopores.

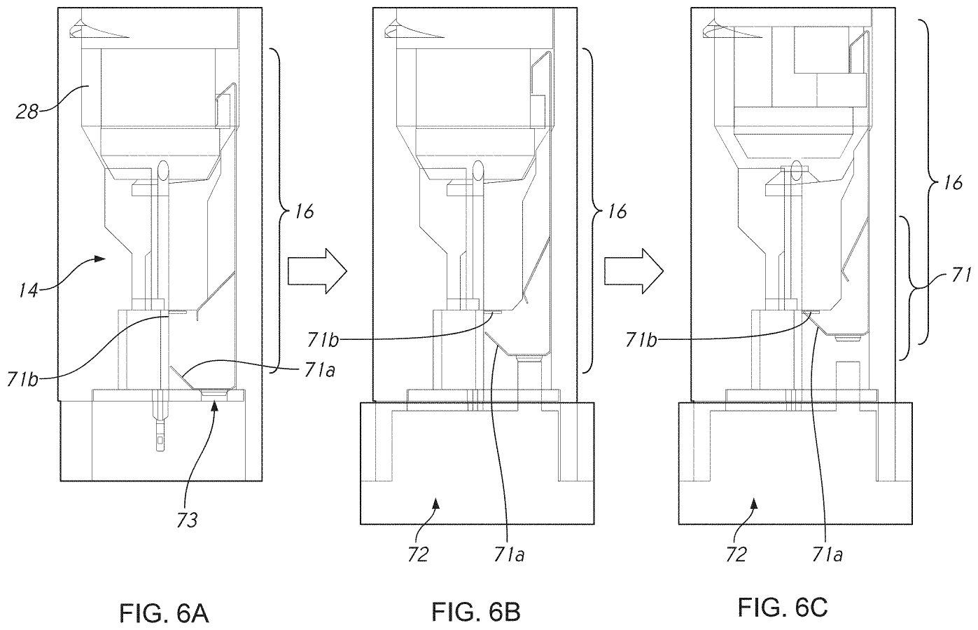

The sensor assembly 14 can further comprise electronic components, such as a memory (e.g., a wafer-level chip size package (WLCSP) electrically erasable programmable read-only memory (EEROM) 70a), a thermometer (e.g., resistance thermometer (RTD) 70b), a connector (e.g., USB connector 70c), a resistor 70d, etc. The processing electronics can be on an external computing device that receives the data by way of a reader 72, which in some embodiments comprises a portable electronic reader. Alternatively, the processing electronics can be in the sensor assembly 14, or in the reader 72. In some embodiments, the thermometer can measure temperature of the test sample and/or the control material, thereby allowing the sensing assembly 14 to compensate for the temperature during analysis. In some embodiments, the sensor assembly 14 can be connected to an external device (e.g., a reader 72, shown in FIGS. 6B-6C) through the connector 70c. When the reader 72 is coupled to the sensor assembly 14, the resistor can sense that the reader 72 is coupled thereby unlocking the mechanical locking structure 16 and/or activating the sensing assembly 14. In some embodiments, when the reader 72 is coupled to the test sampling device 1, the mechanical locking structure 16 can be unlocked. The reader 72 can push an unlock button 73 (see FIG. 1B) that is disposed on a bottom side of the test sampling device 1. A force can be applied to the sample mixing compartment housing 28 and/or the cap 12 to cause a mechanical movement. In some embodiments, the sample mixing compartment housing 28 can be moved relative to the cartridge housing 10. For example, the sample mixing compartment housing 28 and/or the cap 12 can be twisted or rotated relative to one another. In such embodiments, the cartridge housing 10 can comprise a female thread and the sample mixing compartment housing 28 can comprise a male thread, or vice versa. When the mechanical locking structure 16 is unlocked, an activation feature 71 can be enabled and the reader 72 can sense resistance in a circuit from the resistor of the sensor assembly 14. The activation feature 71 can include a lock clip 71a and a detect pin 71b that engages/disengages in response to coupling the sample testing device 1 to the reader 72 and/or the twisting action. In response to the twist of sample mixing compartment housing 28 and/or the cap 12, the separator 20 can open to allow the test sample to flow from the sample mixing compartment 24 to the sensing compartment 26 or the sample reservoir 60 by way of the aperture 25 in the fluid flow 27. When the separator 20 opens, the reader 72 can detect a shortage in the circuit. When the short circuit is detected, the reader 72 can initiate reading and analyzing sensed data received from the sensor assembly 14. Table 1 below shows an example relationship between the mechanical movement of the sample mixing compartment and electrical status of the circuit.

TABLE 1
(Logic Table)

| Physical Status | Circuit Status |
|---|---|
| Unplugged | Open |
| Plugged | Resistant |
| Plugged and turned | Short |

In some embodiments, the testing tube can comprise a mechanical locking structure 16. For example, the mechanical locking structure 16 can comprise a pin 16a that can restrict movement of the cap 12. The mechanical locking structure 16 can be unlocked when the reader 72 is inserted and the cap 12 is lifted relative to the mechanical locking structure 16 (see FIGS. 6A-6C).

FIGS. 6A-6C are side views of the mechanical locking structure 16 with the three statuses in Table 1. FIG. 6A is a side view of the mechanical locking structure 16 having an unplugged physical status and an open circuit status. In other words, a lock clip 71a and a detect pin 71b of an activation feature 71 is not in electrical contact with each other. FIG. 6B is a side view of the mechanical locking structure 16 having a plugged physical status. in the plugged state of FIG. 6B, the reader 72 senses resistance in a circuit from the resistor 70d of the sensor assembly 14 in the plugged physical status. FIG. 6C is a side view of the mechanical locking structure 16 having a plugged and turned physical status. The sample mixing compartment housing 28 and/or the cap 12 can be twisted relative to the sensing compartment 30, and the lock clip 71a of the activation feature 71 can be lifted to make contact with the detect pin 71b of the activation feature 71. Due to the contact between the lock clip 71a and the detect pin 71b, the reader 72 can detect a short in the circuit in the turned physical status when the lock clip 71a makes contact with the detect pin 71b. The reader 72 can receive data from the sensor assembly 14 of the sample testing device 1. In some embodiments, the reader 72 can analyze the data and determine the components of the fluid sample. In some embodiments, the reader may indicate a positive test result, corresponding to a situation in which a designated amount (i.e., an amount in excess of a detection limit of the sensing element 34) of target components, or molecules, have been detected (or sensed) in the fluid sample by the sensing element 24, or a negative test result, corresponding to a situation in which a designated amount target components, or molecules, have not been detected (or sensed) in the fluid sample by the sensing element 24.

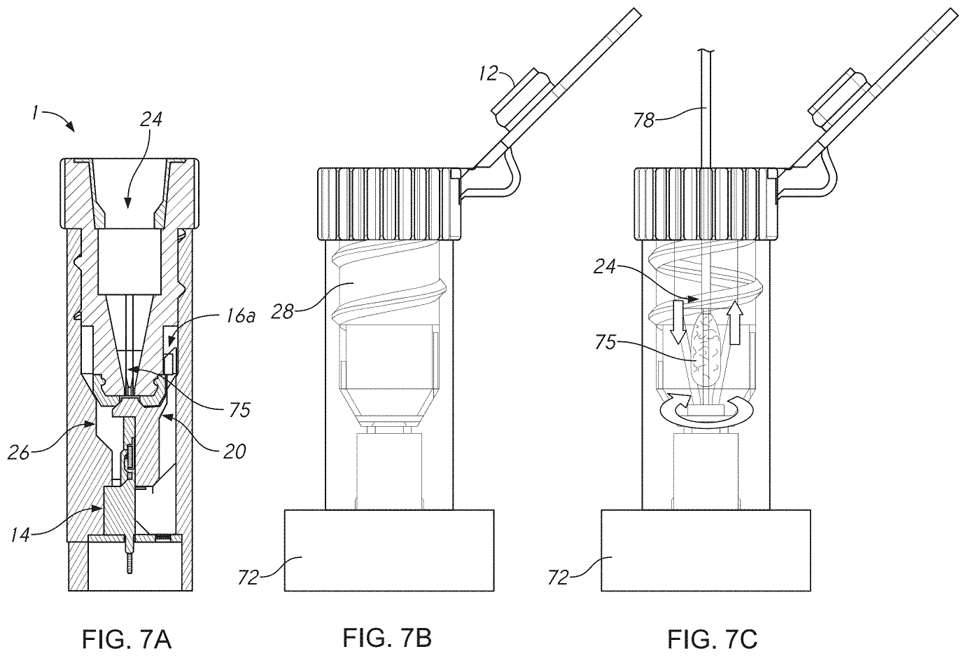

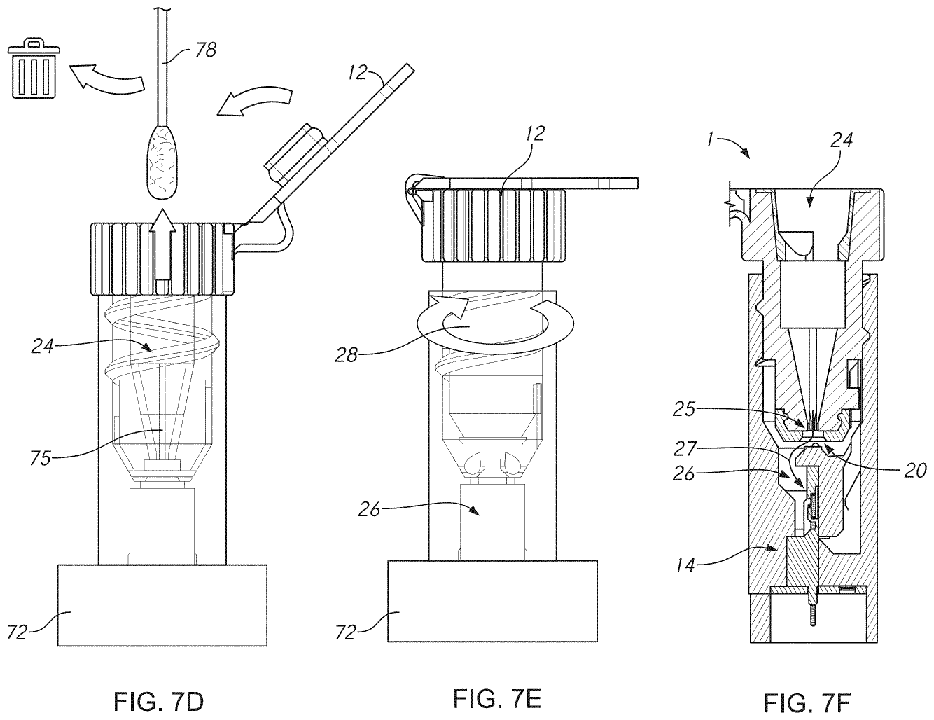

FIGS. 7A-7F show various steps in a process of testing a sample, according to an embodiment. FIG. 7A is a schematic cross-sectional side view of a sample testing device 1 in a step in the process. In FIG. 7A, a solution 75 can be provided in the sample mixing compartment 24. In the step of FIG. 7A, the sample testing device 1 is in the unplugged state, with the circuit indicating an open circuit status. FIG. 7B is a schematic side view of the sample testing device 1 in a step in the process. The sample testing device 1 can be plugged into a reader 72. A cap 12 of the sample testing device 1 can be opened for receiving a test sample. In FIG. 7B, the sample testing device 1 has moved to the plugged state, with the circuit indicating a resistance. FIG. 7C is a schematic side see-through view of the sample testing device 1 with a swab 78 in a step in the process. The test sample can be provided by way of the swab 78. The test sample can be mixed with the solution 75 in the sample mixing compartment 24. For example, the swab 78 with the test sample can be inserted into the sample mixing compartment 24 and stirred with the solution 75. FIG. 7D is a schematic side see-through view of the sample testing device 1 with the swab 78 in a step in the process. At FIG. 7D, the swab 78 can be removed or pulled out from the sample mixing compartment 24. The swab 78 can be discarded after removing the swab 78 from the sample mixing compartment 24, and the cap 12 can be closed. FIG. 7E is a schematic side see-through view of the sample testing device 1 in a step in the process. At FIG. 7E, the sample mixing compartment housing 28 and/or the cap 12 can be twisted relative to the sensing compartment 26. For example, the sample mixing compartment housing 28 and/or the cap 12 can be twisted by a one-fourth turn relative to the sensing compartment 26. In some embodiments, a separator 20 can open in response to the twist to be in an opened state. The test sample can transfer from the sample mixing compartment 24 to the sensing compartment 26 when the separator 20 is in the opened state. In FIG. 7E, the device 1 has moved to a plugged and turn state, in which the circuit indicates a short circuit condition. A sensing element 34 in the sample testing device 1 can sense the test sample and the reader 72 can start reading sensed data. FIG. 7F is a schematic cross-sectional side view of the sample testing device 1 after testing or detecting the test sample. The sample testing device 1 can be removed or unplugged from the reader 72, and the sample testing device 1 can be discarded.

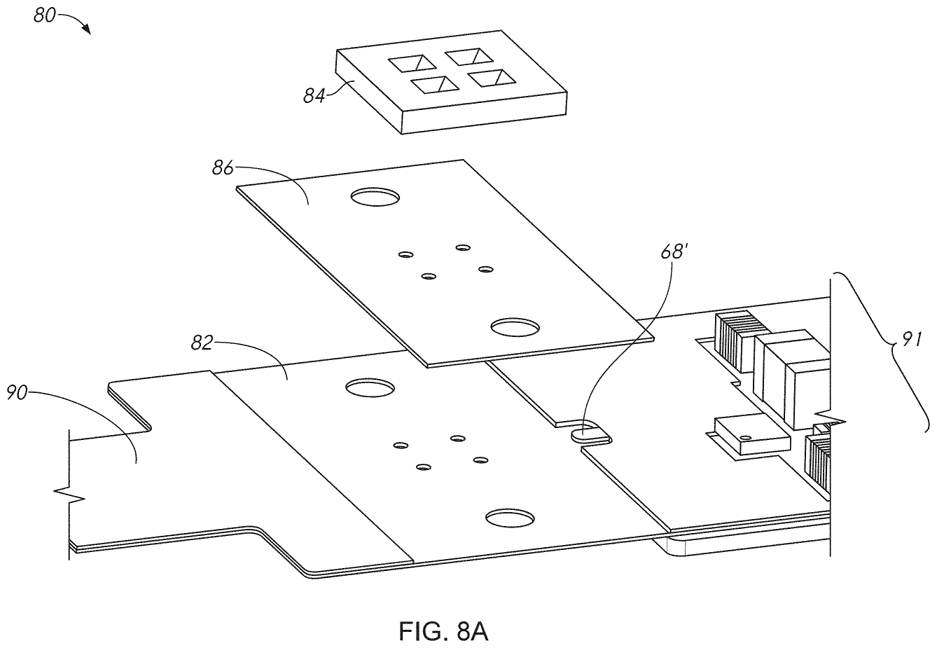

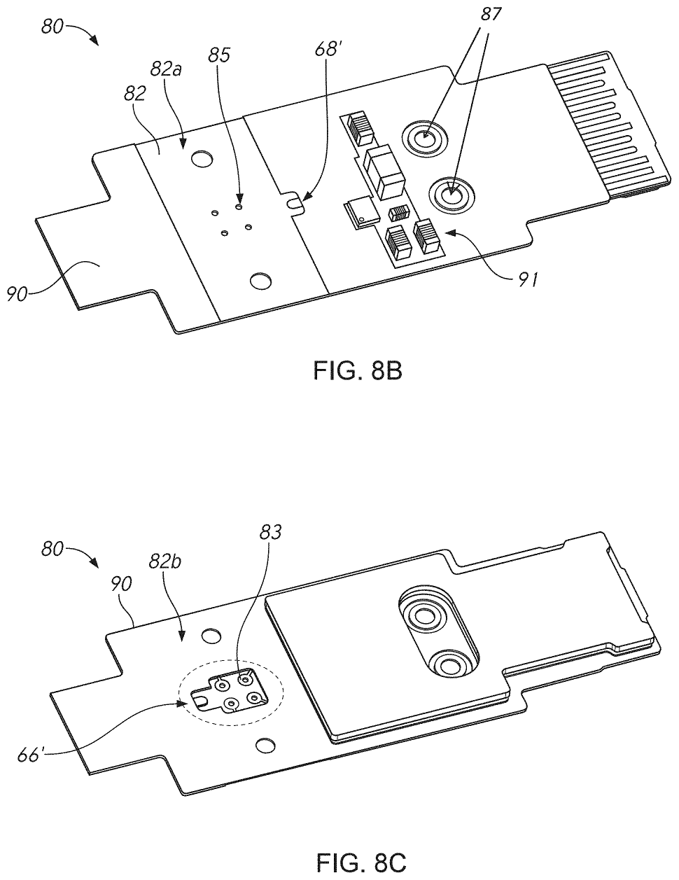

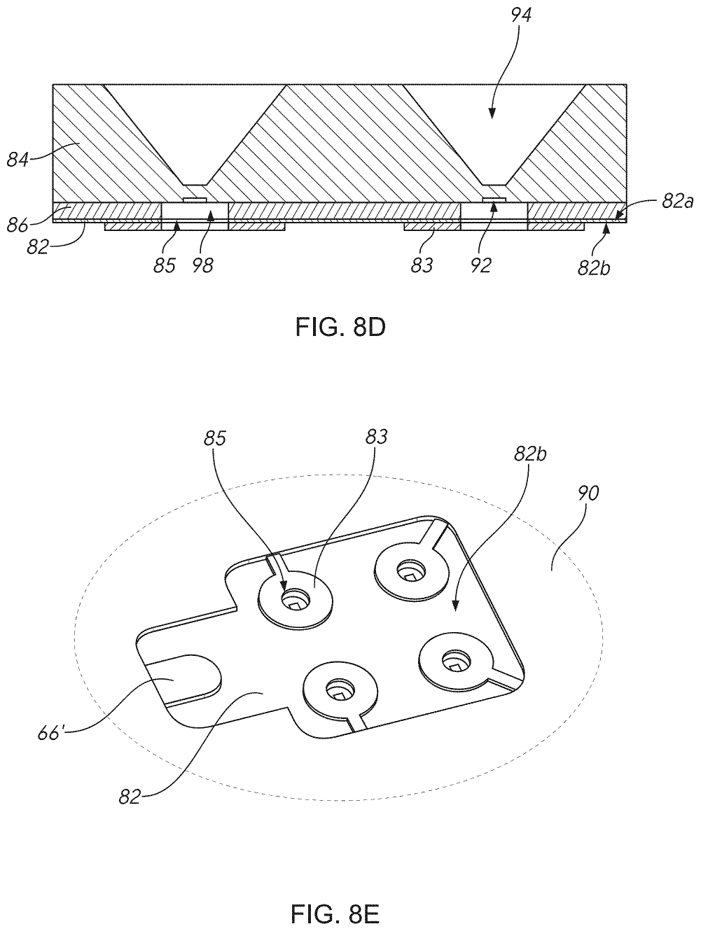

FIGS. 8A-8E are various views of a sensor assembly 80 according to an embodiment. FIG. 8A is a schematic exploded view of the sensor assembly 80 having a substrate 82, a sensing element 84, and an adhesion layer 86. FIG. 8B is a schematic perspective top view of the sensor assembly 80 without the sensing element 84 and the adhesion layer 86. FIG. 8C is a schematic perspective bottom view of the sensor assembly 80 without the sensing element 84 and the adhesion layer 86. FIG. 8D is a schematic cross-sectional side view of a portion of the sensor assembly 80. FIG. 8E is a schematic perspective view of a plurality of electrodes 83 of the sensor assembly 80. In some embodiments, the sensor assembly 80 can be used in the sample testing device 1 described above in place of the sensor assembly 14.

The sensor assembly 80 can include the substrate 82, a sensing element 84 that is coupled to a first side 82a the substrate 82 by way of an adhesion layer 86, a cover layer 90 over the substrate 82. The sensor assembly 80 can include electronic components 91 mounted on the substrate 82. The electronic components, 91 can comprise, for example, a memory (e.g., a WLCSP electrically erasable programmable read-only memory (EEROM)), a thermometer (e.g., resistance thermometer (RTD)), a connector (e.g., USB connector), a resistor, etc. The substrate 82 can include the plurality of electrodes 83 on a second side 82b of the substrate 82 opposite the first side 82a.

In some embodiments, the substrate 82 can comprise a flexible substrate. For example, the substrate 82 can comprise a polyimide flexible substrate including a nonconductive material and a plurality of embedded metal traces, a printed circuit board (PCB), a lead frame (e.g., a pre-molded lead frame) substrate, a ceramic substrate, etc.

The substrate 82 can comprise a plurality of electrodes 83 formed on the second side 82b of the substrate 82. The plurality of electrodes 83 can function as working electrodes. The plurality of electrodes 83 can comprise a conductive material. In some embodiments, the plurality of electrodes 83 can comprise platinum. In some embodiments the plurality of electrodes 83 can comprise a ring of conductive material disposed around a hole 85 in the substrate 82. The substrate 82 can also comprise through holes 87. Detect pins (not shown) can go through the through holes 87.

The substrate can comprise a reference electrode 66′ that is formed on the second side 82b of the substrate 82, and a counter electrode 68′ on the first side 82a of the substrate 82. The reference electrode 66′ can at least partially be exposed to a sample reservoir, and the counter electrode 68′ can at least partially be exposed to a buffer reservoir. The reference electrode 66′ and the counter electrode 68′ can comprise any suitable materials. In some embodiments, the reference electrode 66′ can comprise silver (Ag), silver chloride (AgCl), or the like material. In some embodiments, the counter electrode 68′ can comprise platinum (Pt), silver (Ag), or Gold (Au). In some embodiments the counter electrode 68′ can be electrically grounded. The reference electrode 66′, the plurality of electrodes 83, and the counter electrode 68′ can be used to monitor the disturbance in the current measured through the plurality of electrodes 83. The reference electrode 66′ can sense bulk properties of the test sample and the counter electrode 68′ can sense bulk properties of the control material. The control material can short the counter electrode 68′.

The sensing element 84 can comprise a semiconductor (e.g., silicon) die. In some embodiments, the sensing element 84 can comprise a bare die. In some embodiments, the sensing element 84 includes no electrical interconnect, no active circuitry, and/or no metal therein or thereon. Such a sensing element 84 that does not include an electrical interconnect and/or active circuitry can be manufactured with fewer steps relative to a similar sensing element with an electrical interconnect and/or circuitry formed therein or thereon. In some embodiments, the sensing element 84 can comprise a plurality of nanopores 92. The plurality of nanopores 92 can extend through a portion of a thickness of the sensing element 34. The sensing element 34 can measure a current through the plurality of nanopores 92.

The sensing element 84 can comprise cavities 94 and a protein layer (not shown) in the cavities 94. In some embodiments, the protein layer can comprise a plurality of portions and each of the plurality of portions of the protein layer can be spotted in each nanopore of the plurality of nanopores 92. In some embodiments, each cavity of the cavities 94 can have different protein in order to detect different biological species. The cavities 94 can be exposed to the control liquid.

In some embodiments, the adhesion layer 86 can comprise a double sided tape. The adhesion layer 86 can include a plurality of holes 98 through a thickness of the adhesion layer 86. The holes 98 in the adhesion layer 86, the holes 85 in the substrate 82, and the plurality of nanopores 92 can align with each other. The plurality of nanopores 92 can be exposed to a sample reservoir 60 through the holes 98 in the adhesion layer 86, the holes 85 in the substrate 82. When the sample liquid is provided into the sample reservoir 60, the nanopores 92 can contact the sample liquids.

As compared to a sensing element that includes an electrical interconnect or circuitry, the sensing element 84 can be manufactured with fewer fabrication steps and/or have smaller size. The substrate 82 with the plurality of electrodes 83 can enable the sensor assembly 80 to include such a sensing element (e.g., the sensing element 84) that does not include an electrical interconnect or circuitry. In some embodiments, the substrate 82 can provide improved reliability because the plurality of electrodes 83 can be provided directly on the substrate 82. The sensing assembly 80 can be implemented and used in a similar manner as the sensing assembly 14. In some embodiments, the sensing assembly 80 can detect a composition of a test sample in a similar process as disclosed in FIGS. 7A-7F.

Due to the nature of functionalization, once particular probe molecules of the sensing element 34 have been exposed to a target chemical or biomolecule (also hereinafter alternatively referred to herein as a “target analyte”), they are bound together and cannot easily unbind, rendering the sensing element 34 non-reusable. As a result, the efficacy of the functionalization of the sensing element 34 cannot be tested before use. A negative test result that is due to the fact that the target analyte was not present in the test sample or that the level of the target analyte was below the detection limit of the probe molecules would be proper (i.e., a true negative). Alternatively, a negative test result may be due to the fact that either the sample testing device 1 overall or the sensing element 34 in particular is not working properly (e.g., due to improper functionalization of the sensing device), in which case, the negative test result would be improper (i.e., a false negative).

In accordance with features of embodiments described herein, in order to test the proper functionalization of the sensing element 34 to confirm the accuracy of a negative test result, thereby to prevent false negative results, subsequent to indication of a negative test result using the sample testing device 1 as described above, the sensing element 34 may be exposed to a test confirmation sample including an amount of the target molecule (or a recombinant protein thereof) above the detection limit of the sensing element and then measured and analyzed (e.g., using the reader 72). If the reader 72 indicates a positive result after exposure of the sensing device 34 to the test confirmation sample, the sensing device 34 is deemed to be properly functionalized and the original negative test result is deemed a true negative (and valid). In contrast, if the reader 72 indicates a negative result after exposure of the sensing device 34 to the test confirmation sample, the sensing device is deemed to be improperly functionalized and the original negative test result is deemed invalid. In this manner, negative test results may be validated, or verified, easily, accurately, and quickly immediately after the result is indicated by the reader 72. In certain embodiments, negative test results may be validated simultaneously with the results themselves.

In particular embodiments, the test confirmation sample may be stored and supplied internally to the sample testing device 1 and only released to the sensing compartment 26 after indication of a negative test result by the reader 72.

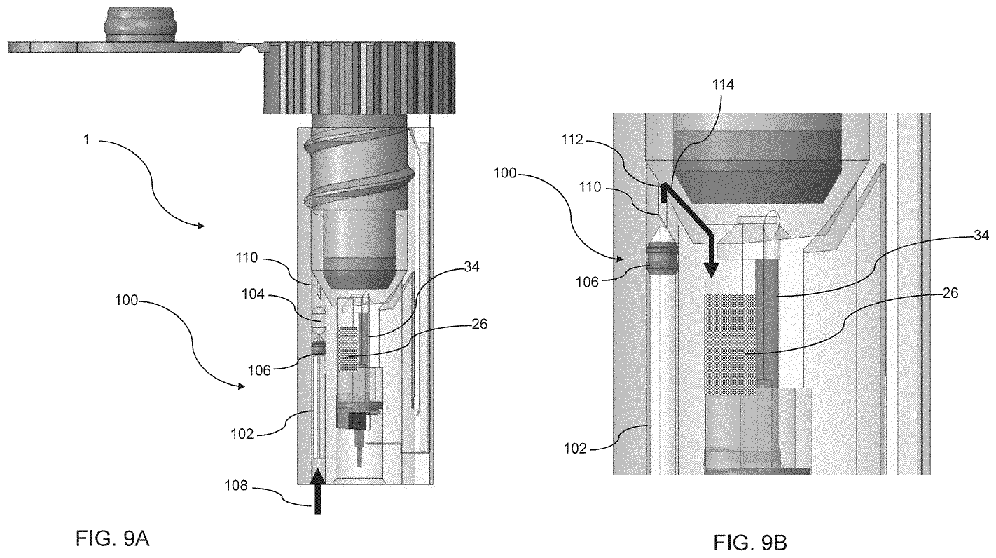

FIGS. 9A and 9B are schematic cross-sectional side views illustrating an internal positive control mechanism 100 for the sample testing device 1 in accordance with one embodiment described herein. As shown in FIG. 9A, the internal positive control mechanism 100 includes a compartment 102 in which a capsule 104 containing a test confirmation sample including a detectable amount of the targeted molecule (or a recombinant protein thereof). In particular embodiments, the test confirmation sample in the capsule 104 comprises a fluid. A plunger 106 is also disposed within the compartment 102 and arranged within the compartment 102 such that movement of the plunger 106 toward the capsule 104 (e.g., in a direction indicated by an arrow 108) forces the capsule against a spine 110 or other rigid object having a sharp point capable of puncturing the capsule 104 to release the fluid test confirmation sample contained therein. In particular embodiments, movement of the plunger 106 in the direction 108 is initiated by depressing a button on or associated with the reader 72 (not shown in FIGS. 9A and 9B) after a negative test result is indicated by the reader 72 (not shown in FIGS. 9A and 9B). Movement of the plunger 106 in the direction 108 may actuated and controlled by the reader 72 (not shown in FIGS. 9A and 9B).

Referring to FIG. 9B, continued movement of the plunger 106 in the direction 108 forces the fluid test confirmation sample through an aperture 112 and into the sensing compartment 26, as indicated by an arrow 114, where it is exposed to the sensing element 34 and the results are indicated by the reader 72 (not shown in FIGS. 9A and 9B) as described above.

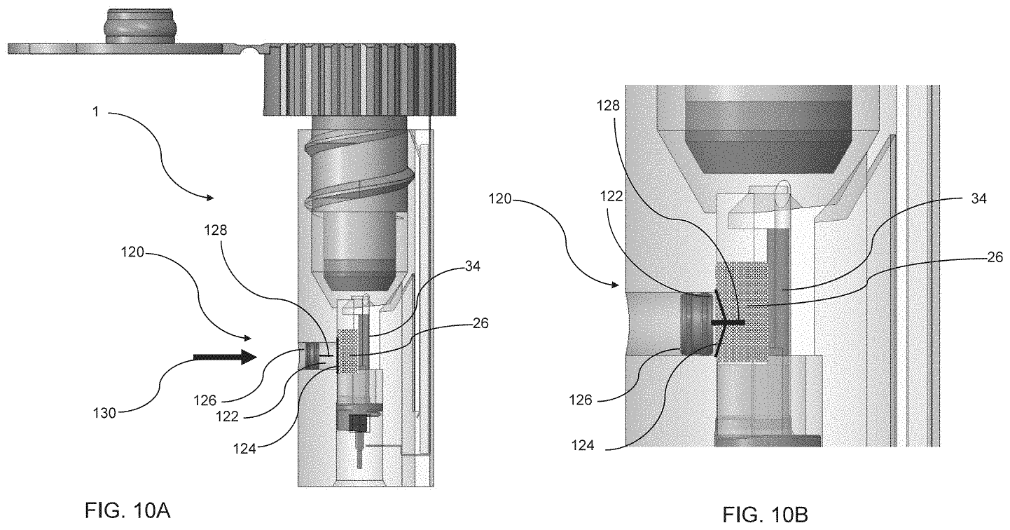

FIGS. 10A and 10B are schematic cross-sectional side views illustrating an internal positive control mechanism 120 for the sample testing device 1 in accordance with an alternative embodiment described herein. As shown in FIG. 10A, the internal positive control mechanism 120 includes a compartment 122 containing a test confirmation sample including a detectable amount of the targeted molecule (or a recombinant protein thereof). In particular embodiments, the test confirmation sample in the compartment 122 comprises a fluid. The compartment 122 is separated from the sensing compartment 26 by a membrane 124, which may include metal foil, plastic, or any other suitable material, such that the test confirmation sample is contained within the compartment 122.

The internal positive control mechanism 120 further includes a plunger 126 including a spine (or other rigid object having a sharp point capable of puncturing the membrane 124) 128 disposed on an end thereof proximate the membrane 124. As best shown in FIG. 10B, actuation of the plunger 126 in a direction indicated by an arrow 130 forces the spine 128 toward and through the membrane 124, puncturing it and allowing the test confirmation sample to flow into the sensing compartment 26, as indicated by an arrow 132, where it is exposed to the sensing element 34 and the results are indicated by the reader 72 (not shown in FIGS. 10A and 10B) as described above. It will be recognized that the plunger 126 may be actuated by a user or device applying force to an end of the plunger 126 distal from the membrane 124 in the direction 130 sufficient to cause the spine 128 to puncture the membrane 124.

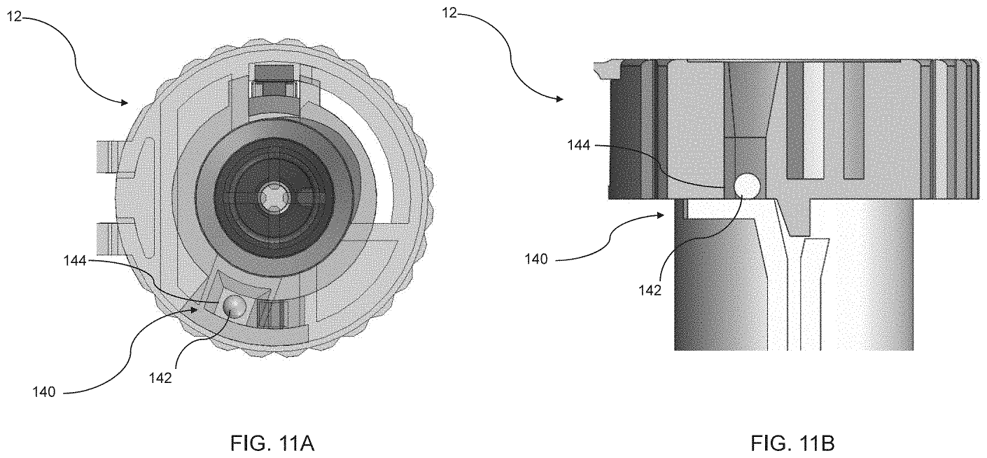

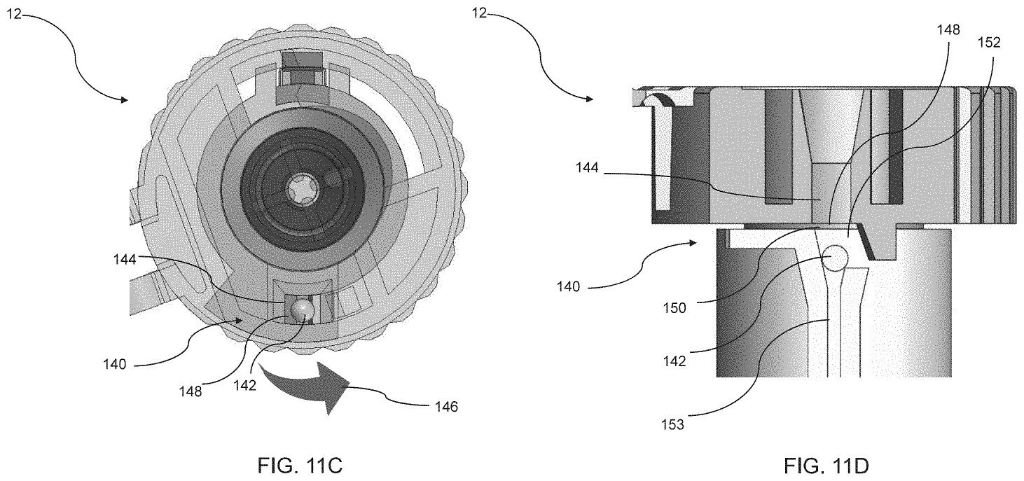

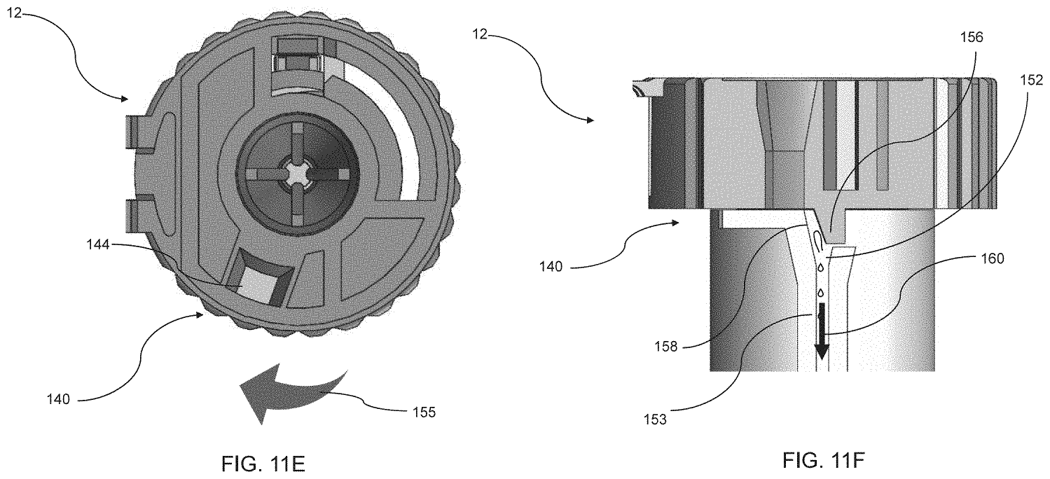

FIGS. 11A-11F are various schematic cross-sectional top and side views illustrating an internal positive control mechanism 140 for the sample testing device 1 in accordance with another alternative embodiment described herein.

Referring first to FIGS. 11A and 11B, the internal positive control mechanism 140 includes a capsule 142 containing a test confirmation sample including a detectable amount of the targeted molecule (or a recombinant protein thereof). In particular embodiments, the test confirmation sample in the capsule 142 comprises a fluid. In particular embodiments, the capsule 142 is spherically shaped. The capsule 142 is contained in a compartment 144 provided in the cap 12 of the sample testing device 1.

Referring now also to FIGS. 11C and 11D, in the particular embodiment illustrated in the figures, rotating the cap 12 in a direction indicated by arrow 146 causes an aperture 148 in the compartment 144 to align with an aperture 150 such that the capsule 142 is released from the compartment 146 and drops into a chamber 152 where it is suspended over a channel 153 leading to the sensing compartment 26 (not shown in FIGS. 11A-11F).

Referring now also to FIGS. 11E-11F, after the capsule 142 is released from the compartment 146 into the chamber 152, movement of the cap 12 in a direction indicated by an arrow 154 causes the capsule 142 to be crushed between a flange 156 disposed on a bottom surface of the cap 12 and a side 158 of the chamber 152, releasing the test confirmation sample fluid into the sensing compartment 26 (not shown in FIGS. 11A-11F) via the channel 153, as indicated by an arrow 160, where it is exposed to the sensing element 34 and the results are indicated by the reader 72 (not shown in FIGS. 11A-11F) as described above.

In an alternative embodiment, the test confirmation sample may be provided separately from the sample testing device 1 (e.g., stored in a pipette or deposited on a cotton swab) and added to the sensing compartment 26 after indication of a negative test result by the reader 72 (not shown in FIGS. 11A-11F).

In another alternative embodiment, a trace amount of the target molecule (i.e., an amount slightly above the detection limit of the sensing element 34) may be included in the solution 75 contained in the sample mixing compartment 24 such that there would always be an amount of the target molecule to be detected 34. As a result, functionalization of the sensing element 34 could be verified simultaneously with testing. In particular, in this embodiment, indication by the reader 72 (not shown in FIGS. 11A-11F) that no level of the target molecule had been sensed would correspond to a false negative test result. Indication by the reader that a trace amount of the target molecule had been sensed would correspond to a true negative test result. Indication by the reader that more than the trace amount of the target molecule had been sensed may correspond to a positive test result.

The following examples are provided by way of illustration.

Example 1 provides a method of verifying a negative test result obtained by exposing a sensing element functionalized to detect a target analyte to a test sample, the method including subsequent to or simultaneously with the exposing the sensing element to the test sample, exposing the sensing element to a test confirmation sample, the test confirmation sample including at least one of the target analyte in an amount greater than a detection limit of the sensing element and a recombinant protein of the target analyte in an amount greater than a detection limit of the sensing element; and performing a measurement using the sensing element to obtain a subsequent test result.

Example 2 provides the method of example 1, where the subsequent test result includes a positive test result, where the original negative test measurement is deemed to be a true negative test result.

Example 3 provides the method of any of examples 1-2, where the subsequent test result includes a negative test result, where the original negative test measurement is deemed to be a false negative test result.

Example 4 provides the method of any of examples 1-3, where the sensing element includes a plurality of nanopores.

Example 5 provides the method of any of examples 1-4, where the sensing element is housed in a cartridge,

Example 6 provides the method of example 5, further including connecting the cartridge to a portable electronic reader, the portable electronic reader providing an indication of the subsequent test result.

Example 7 provides the method of example 5, where the test confirmation sample is stored internally to the cartridge.

Example 8 provides the method of example 5, where the test confirmation sample is introduced into the cartridge using an external device.

Example 9 provides the method of example 8, where the external device includes at least one of a pipette and a cotton swab.

Example 10 provides an apparatus for confirming a negative test result obtained by exposing a sensing element functionalized to detect a target analyte to a test sample, the method including a first compartment configured to retain a test confirmation sample, the test confirmation sample including at least one of the target analyte in an amount greater than a detection limit of the sensing element and a recombinant protein of the target analyte in an amount greater than a detection limit of the sensing element; a second compartment configured to receive the test confirmation sample from the first compartment, where the sensing element is disposed in the second compartment; a separator disposed between and separating the first compartment and the second compartment; and a mechanism for releasing the test confirmation sample from the first compartment into the second compartment to expose the sensing element to the test confirmation sample.

Example 11 provides the apparatus of example 10, where the test confirmation sample includes a capsule disposed in the first compartment.

Example 12 provides the apparatus of example 11, where the mechanism includes a plunger for pressing the capsule against a rigid spine with a force sufficient to puncture the capsule and release the test confirmation sample from the capsule.

Example 13 provides the apparatus of any of examples 10-12, where the plunger is in the first compartment.

Example 14 provides the apparatus of any of examples 10-13, where the separator includes a membrane.

Example 15 provides the apparatus of example 14, where the mechanism includes a plunger including a rigid spine on an end of the plunger proximate the membrane.

Example 16 provides the apparatus of example 15, where actuation of the mechanism punctures the membrane to release the test confirmation sample from the first compartment to the second compartment.

Example 17 provides the apparatus of any of claims 10-16, wherein the sensing element comprises a plurality of nanopores.

Example 18 provides an apparatus for confirming a negative test result obtained by exposing a sensing element functionalized to detect a target analyte to a test sample, the method including a cartridge including a main body and a cap rotatably connected to the main body; a first compartment in the cap of the cartridge, the first compartment configured to retain a test confirmation sample, the test confirmation sample including at least one of the target analyte in an amount greater than a detection limit of the sensing element and a recombinant protein of the target analyte in an amount greater than a detection limit of the sensing element; and a second compartment in the main body of the cartridge, the second compartment configured to receive the test confirmation sample from the first compartment, where the sensing element is disposed in the second compartment, where rotation of the cap relative to the main body in a first direction releases the test confirmation sample from the first compartment into a chamber in the main body.

Example 19 provides the apparatus of example 18, where the test confirmation sample includes a sphere-shaped capsule.

Example 20 provides the apparatus of example 19, where cap further includes a flange on an inner surface thereof inside the main body, and where rotation of the cap relative to the main body in a second direction opposite the first direction crushes the sphere-shaped capsule against an inner wall of the chamber to release the test confirmation sample into the second compartment

Unless the context clearly requires otherwise, throughout the description and the claims, the words “comprise,” “comprising,” “include,” “including,” and the like are to be construed in an inclusive sense, as opposed to an exclusive or exhaustive sense; that is to say, in the sense of “including, but not limited to.” The word “coupled,” as generally used herein, refers to two or more elements that may be either directly coupled to each other, or coupled by way of one or more intermediate elements. Likewise, the word “connected,” as generally used herein, refers to two or more elements that may be either directly connected, or connected by way of one or more intermediate elements. Additionally, the words “herein,” “above,” and words of similar import, when used in this application, shall refer to this application as a whole and not to any particular portions of this application. Where the context permits, words in the above Detailed Description using the singular or plural number may also include the plural or singular number respectively. Where the context permits, the word “or” in reference to a list of two or more items is intended to cover all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments.

For purposes of summarizing the disclosed embodiments and the advantages achieved over the prior art, certain objects and advantages have been described herein. Of course, it is to be understood that not necessarily all such objects or advantages may be achieved in accordance with any particular embodiment. Thus, for example, those skilled in the art will recognize that the disclosed implementations may be embodied or carried out in a manner that achieves or optimizes one advantage or group of advantages as taught or suggested herein without necessarily achieving other objects or advantages as may be taught or suggested herein.

All of these embodiments are intended to be within the scope of this disclosure. These and other embodiments will become readily apparent to those skilled in the art from the following detailed description of the embodiments having reference to the attached figures, the claims not being limited to any particular embodiment(s) disclosed. Although this certain embodiments and examples have been disclosed herein, it will be understood by those skilled in the art that the disclosed implementations extend beyond the specifically disclosed embodiments to other alternative embodiments and/or uses and obvious modifications and equivalents thereof. In addition, while several variations have been shown and described in detail, other modifications will be readily apparent to those of skill in the art based upon this disclosure. It is also contemplated that various combinations or sub-combinations of the specific features and aspects of the embodiments may be made and still fall within the scope. It should be understood that various features and aspects of the disclosed embodiments can be combined with, or substituted for, one another in order to form varying modes of the disclosed implementations. For example, circuit blocks described herein may be deleted, moved, added, subdivided, combined, and/or modified. Each of these circuit blocks may be implemented in a variety of different ways. Thus, it is intended that the scope of the subject matter herein disclosed should not be limited by the particular disclosed embodiments described above, but should be determined by a fair reading of the claims that follow.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke 35 U.S.C. § 112(f) as it exists on the date of the filing hereof unless the words “means for” or “steps for” are specifically used in the particular claims; and (b) does not intend, by any statement in the disclosure, to limit this disclosure in any way that is not otherwise reflected in the appended claims.

What is claimed is:

1. A method of verifying a negative test result obtained by exposing a sensing element functionalized to detect a target analyte to a test sample, the method comprising:
subsequent to the exposing the sensing element to the test sample, exposing the sensing element to a test confirmation sample, the test confirmation sample comprising at least one of the target analyte in an amount greater than a detection limit of the sensing element and a recombinant protein of the target analyte in an amount greater than a detection limit of the sensing element; and
performing a measurement using the sensing element to obtain a subsequent test result.

2. The method of claim 1, wherein the subsequent test result comprises a positive test result, wherein the original negative test measurement is deemed to be a true negative test result.

3. The method of claim 1, wherein the subsequent test result comprises a negative test result, wherein the original negative test measurement is deemed to be a invalid test result.

4. The method of claim 1, wherein the sensing element comprises a plurality of nanopores.

5. The method of claim 1, wherein the sensing element is housed in a cartridge.

6. The method of claim 5, further comprising connecting the cartridge to an electronic reader, the portable electronic reader providing an indication of the subsequent test result.

7. The method of claim 5, wherein the test confirmation sample is stored internally to the cartridge.

8. The method of claim 5, wherein the test confirmation sample is introduced into the cartridge using an external device.

9. The method of claim 8, wherein the external device comprises at least one of a pipette and a swab.

10. An apparatus for confirming a negative test result obtained by exposing a sensing element functionalized to detect a target analyte to a test sample, the method comprising:
a first compartment configured to retain a test confirmation sample, the test confirmation sample comprising at least one of the target analyte in an amount greater than a detection limit of the sensing element and a recombinant protein of the target analyte in an amount greater than a detection limit of the sensing element;
a second compartment configured to receive the test confirmation sample from the first compartment, wherein the sensing element is disposed in the second compartment;
a separator disposed between and separating the first compartment and the second compartment; and
a mechanism for releasing the test confirmation sample from the first compartment into the second compartment to expose the sensing element to the test confirmation sample.

11. The apparatus of claim 10, wherein the test confirmation sample comprises a capsule disposed in the first compartment.

12. The apparatus of claim 11, wherein the mechanism comprises a plunger for pressing the capsule against a rigid spine with a force sufficient to puncture the capsule and release the test confirmation sample from the capsule.

13. The apparatus of claim 12, wherein the plunger is in the first compartment.

14. The apparatus of claim 10, wherein the separator comprises a membrane.

15. The apparatus of claim 14, wherein the mechanism comprises a plunger including a rigid spine on an end of the plunger proximate the membrane.

16. The apparatus of claim 15, wherein actuation of the mechanism punctures the membrane to release the test confirmation sample from the first compartment to the second compartment.

17. The apparatus of claim 10, wherein the sensing element comprises a plurality of nanopores.

18. An apparatus for confirming a negative test result obtained by exposing a sensing element functionalized to detect a target analyte to a test sample, the method comprising:
a cartridge comprising a main body and a cap rotatably connected to the main body;
a first compartment in the cap of the cartridge, the first compartment configured to retain a test confirmation sample, the test confirmation sample comprising at least one of the target analyte in an amount greater than a detection limit of the sensing element and a recombinant protein of the target analyte in an amount greater than a detection limit of the sensing element; and
a second compartment in the main body of the cartridge, the second compartment configured to receive the test confirmation sample from the first compartment, wherein the sensing element is disposed in the second compartment; and
wherein rotation of the cap relative to the main body in a first direction releases the test confirmation sample from the first compartment into a chamber in the main body.

19. The apparatus of claim 18, wherein the test confirmation sample comprises a sphere-shaped capsule.

20. The apparatus of claim 19, wherein cap further comprises a flange on an inner surface thereof inside the main body, and wherein rotation of the cap relative to the main body in a second direction opposite the first direction crushes the sphere-shaped capsule against an inner wall of the chamber to release the test confirmation sample into the second compartment and expose the sensing element to the test confirmation sample.
